(19) United States
(12) Patent Application Publication
(10) Pub. No.: US 2016/0266391 A1
(43) Pub. Date: Sep. 15, 2016

(54) HEAD UP DISPLAY FOR VEHICLE AND CONTROL METHOD THEREOF

(71) Applicant: HYUNDAI MOBIS CO., LTD., Seoul (KR)

(72) Inventors: Sang Hoon HAN, Seongbuk-gu (KR); Jung Hoon SEO, Gangseo-gu (KR); Chul Hyun LEE, Yongin-si (KR); Uhn Yong SHIN, Yongin-si (KR)

(21) Appl. No.: 15/068,298

(22) Filed: Mar. 11, 2016

(30) Foreign Application Priority Data
Mar. 11, 2015 (KR) 10-2015-0033835
Mar. 26, 2015 (KR) 10-2015-0042211

(51) Int. Cl. G02B 27/01; G09G 3/36; G02B 27/00; G09G 3/34

(52) U.S. Cl. CPC G02B 27/0179; G02B 27/0101; G09G 3/3433; G09G 3/36; G02B 27/0093; G02B 2027/0181; G02B 2027/014

(57) ABSTRACT

A head up display (HUD) for a vehicle may include: an aspheric mirror configured to reflect an HUD picture to a windshield; a picture generation unit (PGU) configured to directly project the HUD picture on the aspheric mirror; and a control unit configured to calculate a display level of the HUD picture to be displayed on the windshield, based on eye level information of a driver, and control the PGU to output the HUD picture at a position and area corresponding to the calculated display level.

### CROSS-REFERENCES TO RELATED APPLICATIONS

The present application claims priority to Korean application number 10-2015-0033835, filed on Mar. 11, 2015 and Korean application number 10-2015-0042211, filed on Mar. 26, 2015, which is incorporated by reference in its entirety.

### BACKGROUND

The present disclosure relates to a head up display (HUD) for a vehicle and a control method thereof, and more particularly to, an HUD for a vehicle, which displays HUD information on a windshield of the vehicle.

Recently, as vehicles having an HUD mounted therein are launched on the market, users' attention to the HUD has increased.

The HUD refers to a device which provides driving information of a vehicle or operation information of the vehicle, such as navigation information, within such a range that does not deviates from the front side of a driver or the main visual field of the driver, during the operation of the vehicle. In the early days, the HUD has been developed to provide flight information to a pilot in a state where the HUD is attached on an airplane or fighter plane, during flight operation. This principle has been applied to a vehicle, in order to develop the HUD for a vehicle.

For example, suppose that it takes two seconds for a driver to check a dashboard and then fix his/her gaze to the road, when a vehicle is driven at about 100 km/h. In this case, the vehicle moves about 55 m during the time. Thus, an accident is likely to occur at all times. As one of methods for reducing such a risk, the HUD for a vehicle has been developed. The HUD displays dashboard information (speed, mileage, or RPM) or navigation information on the main visual field of a driver on the windshield. Then, since the driver can recognize important operation information or path information of the vehicle without averting his/her eyes from the road during operation, the HUD enables the driver to drive safely.

The related technology is disclosed in Korean Patent No. 10-0928262 published on Nov. 17, 2009 and entitled “Display device”.

### SUMMARY

Embodiments of the present invention are directed to an HUD for a vehicle, which displays HUD information on a windshield of the vehicle while adjusting the level of an eye box (the visual field of a driver) through a software, without using a physical aspheric lens driving motor, and a control method thereof.

In one embodiment, an HUD for a vehicle may include: an aspheric mirror configured to reflect an HUD picture to a windshield; a picture generation unit (PGU) configured to directly project the HUD picture on the aspheric mirror; and a control unit configured to calculate a display level of the HUD picture to be displayed on the windshield, based on eye level information of a driver, and control the PGU to output the HUD picture at a position and area corresponding to the calculated display level.

The control unit may invert the left and right of the HUD picture to be outputted through the PGU.

The HUD may further include one or more mirrors for reflecting the HUD picture outputted from the PGU to the aspheric mirror.

According to the eye level of the driver, the control unit may rotate the HUD picture based on an arbitrary axis, such that the HUD picture seems to lie in the horizontal direction.

The display level of the HUD picture to be displayed on the windshield and the area and position information corresponding to the display level may be stored in the form of a lookup table in an internal memory.

The HUD may further include: one or more eye level information input units; an information adjusting unit configured to adjust the display level of the HUD picture; and one or more information input units formed in AVN (Audio, Video, and Navigation) devices within the vehicle.

The eye level information may be directly inputted from the driver through an information input unit or information adjusting unit, an external eye level detector may automatically detect and input the eye level information, or the control unit may extract eye level information stored in an internal memory for each driver.

The PGU may include a transparent MEMS (Micro Electro Mechanical System) display device.

The control unit may control turn-on/off of pixels of a transparent MEMS display device included in the PGU or control opening/closing of the shutters of the pixels, based on the display area and position information of the HUD picture to be projected on the windshield through the PUG.

The control unit may control brightness of the HUD picture by adjusting the shutter apertures of pixels of a transparent MEMS display device included in the PGU.

In another embodiment, a control method of an HUD for a vehicle may include: receiving, by a control unit, eye level information of a driver; calculating, by the control unit, a display level of an HUD picture to be displayed on a windshield; and controlling, by the control unit, a PGU to output the HUD picture to a position and area corresponding to the calculated display level on the windshield.

The PGU may be configured to directly project the HUD picture on an aspheric mirror of the HUD.

In the controlling of the PGU to output the HUD picture, when the PGU is configured to directly project the HUD picture on an aspheric mirror of the HUD, the control unit may invert the left and right of the HUD picture to be outputted through the PGU.

In the controlling of the PUG to output the HUD picture, according to the eye level of the driver, the control unit may rotate the HUD picture based on an arbitrary axis, such that the HUD picture seems to lie in the horizontal direction.

The display level of the HUD picture to be displayed on the windshield and the area and position information corresponding to the display level may be stored in the form of a lookup table in an internal memory.

In the receiving of the eye level information of the driver, the control unit may directly receive the eye level information from the driver through an information input unit or information adjusting unit, an external eye level detector may automatically detect and input the eye level information, or the control unit may extract eye level information stored in an internal memory for each driver.

The PGU may include a transparent MEMS display device.

In the controlling of the PGU to output the HUD picture, the control unit may control turn-on/off of pixels of a transparent MEMS display device included in the PGU or control opening/closing of the shutters of the pixels, based on the display area and position information of the HUD picture to be projected on the windshield through the PUG.

In the controlling of the PGU to output the HUD picture, the control unit may control brightness of the HUD picture by adjusting the shutter apertures of pixels of a transparent MEMS display device included in the PGU.

In another embodiment, an HUD for a vehicle may include: a picture output unit configured to output a picture to be projected onto a windshield; an aspheric mirror configured to reflect the picture outputted from the picture output unit onto the windshield; and a control unit configured to determine the projection position of contents to be projected onto the windshield, determine an active area for outputting a picture in an available output area for the picture output unit, based on the determined projection position, and control the picture output unit based on the determined active area.

In another embodiment, a control method of a display device may include: determining, by a control unit, the projection position of contents to be projected onto a windshield; determining, by the control unit, an active area for outputting a picture in an available output area, based on the determined projection position; and outputting, by the control unit, a picture based on the determined active area.

### BRIEF DESCRIPTION OF THE DRAWINGS

FIG. 1 a diagram for describing a structure that adjusts the display level of HUD information by rotating an aspheric mirror in an example of an HUD.

FIG. 2 is a diagram illustrating a schematic configuration of an HUD for a vehicle in accordance with a first embodiment of the present invention.

FIG. 3 is a diagram illustrating a schematic configuration of another HUD for a vehicle in accordance with the first embodiment of the present invention.

FIG. 4 is a flowchart for describing a control method of an HUD in accordance with the first embodiment of the present invention.

FIG. 5 is a diagram for describing a PGU (Picture Generation Unit) control method of the HUD in accordance with the first embodiment of the present invention.

FIG. 6 is a diagram for describing a method for adjusting the display level of HUD information displayed on a windshield in the HUD in accordance with the first embodiment of the present invention.

FIG. 7 is a diagram illustrating a schematic configuration of an HUD for a vehicle in accordance with a second embodiment of the present invention.

FIG. 8 is a diagram for describing a method for adjusting a projection position of contents which are displayed on a windshield by the HUD for a vehicle in accordance with the second embodiment of the present invention.

FIG. 9 is a diagram for describing the shape of a picture projected by the HUD in accordance with the second embodiment of the present invention.

FIG. 10 is a diagram for describing a dimming control method of a picture output unit in the HUD in accordance with the second embodiment of the present invention.

FIG. 11 is a flowchart for describing a control method of an HUD in accordance with the second embodiment of the present invention.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

A HUD may have a function of adjusting the display level of HUD information according to the eye level of a driver.

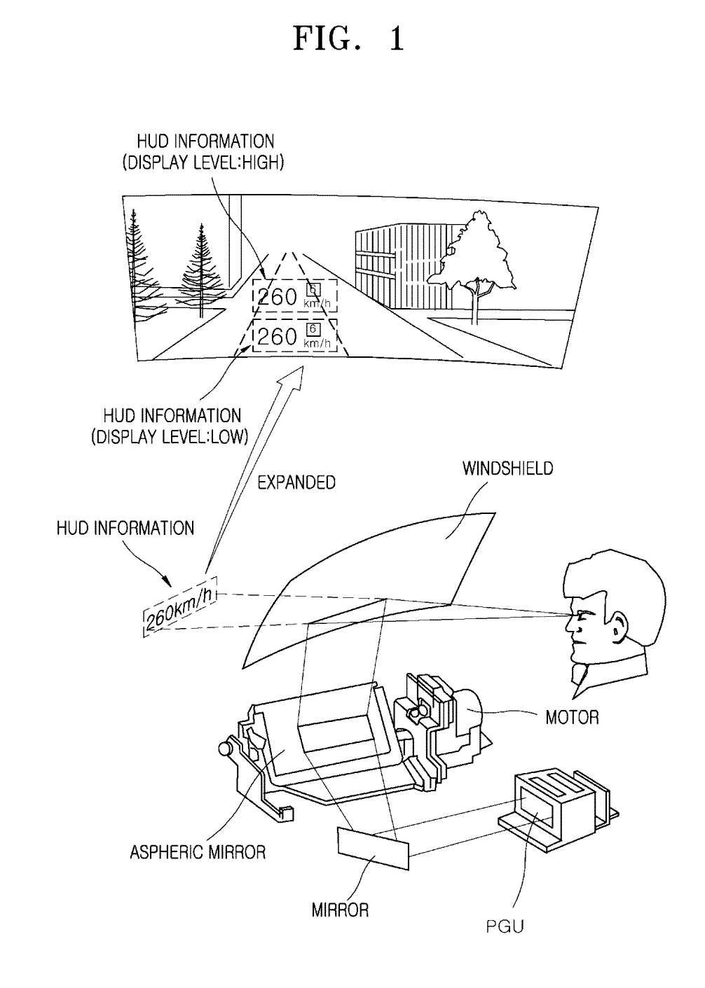

As illustrated in FIG. 1, in one example of the HUD reflects HUD information projected from a PGU (Picture Graphic Unit) through an aspheric mirror, and displays the HUD information on the windshield. The HUD adjusts the reflection angle of the aspheric mirror by rotating a motor connected to the aspheric mirror, thereby adjusting the display level of the HUD information displayed on the windshield.

However, since the windshield is formed in an aspheric shape, an actual HUD for a vehicle reflects HUD information through an aspheric mirror for HUD, corresponding to the aspheric shape of (for example, a curved surface of) a windshield for each type of vehicle, and displays the HUD information on the windshield. However, when the display level of the HUD information displayed on the windshield is changed for example, when the display level of the HUD information becomes higher than a reference position, distortion close to the maximum 30% may occur due to the aspheric characteristic of the windshield.

### First Embodiment

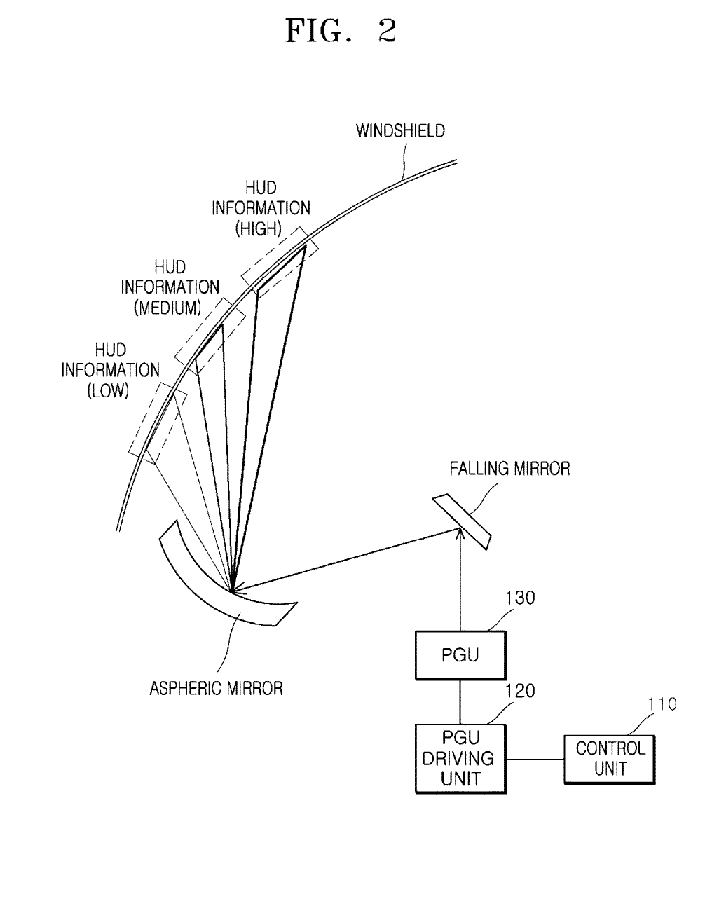

FIG. 2 is a diagram illustrating a schematic configuration of a head up display (HUD) for a vehicle in accordance with a first embodiment of the present invention.

As illustrated in FIG. 2, the HUD for a vehicle in accordance with the first embodiment of the present invention may include a control unit 110, a picture generation unit (PGU) driving unit 120, a PGU 130.

The control unit 110 may generate a picture to be projected on a windshield, according to the eye level of a driver, the picture including HUD information. Then, the control unit 110 calculates a display area and position (or coordinates) of the HUD picture to be projected on the windshield.

According to the eye level of the driver, the control unit 110 may rotate the HUD picture to be projected on the windshield, based on one axis (for example, X-axis).

For example, when the eye level of the driver is high, the display level of the HUD information displayed on the windshield may become low. Thus, the background area (for example, the road area below the horizon) on which the HUD information can be displayed may be widen, compared to the reference level (for example, intermediate level). On the other hand, when the eye level of the driver is low, the display level of the HUD information displayed on the windshield may become high. Thus, the background area (for example, the road area below the horizon) on which the HUD information can be displayed may be narrowed, compared to the reference level. Therefore, according to the size of the background area (for example, road area), the control unit 110 may rotate the HUD picture to be projected on the windshield, based on one axis (for example, X-axis), and display the HUD picture in the form of virtual reality. In embodiments, as the eye level of the driver becomes low, the control unit 110 may significantly adjust the rotation angle of the HUD picture to display a natural HUD picture. The rotation angle may indicate an angle at which the HUD picture seems to lie in the horizontal direction.

In order to generate an HUD picture to be projected on the windshield, the control unit 110 may receive HUD information from electronic devices within the vehicle, for example, a navigation system, a dashboard, a multimedia device and the like.

The HUD information may indicate information to be projected on the windshield through the HUD, and the HUD picture to be projected on the windshield may include a composite picture containing one or more pieces of HUD information.

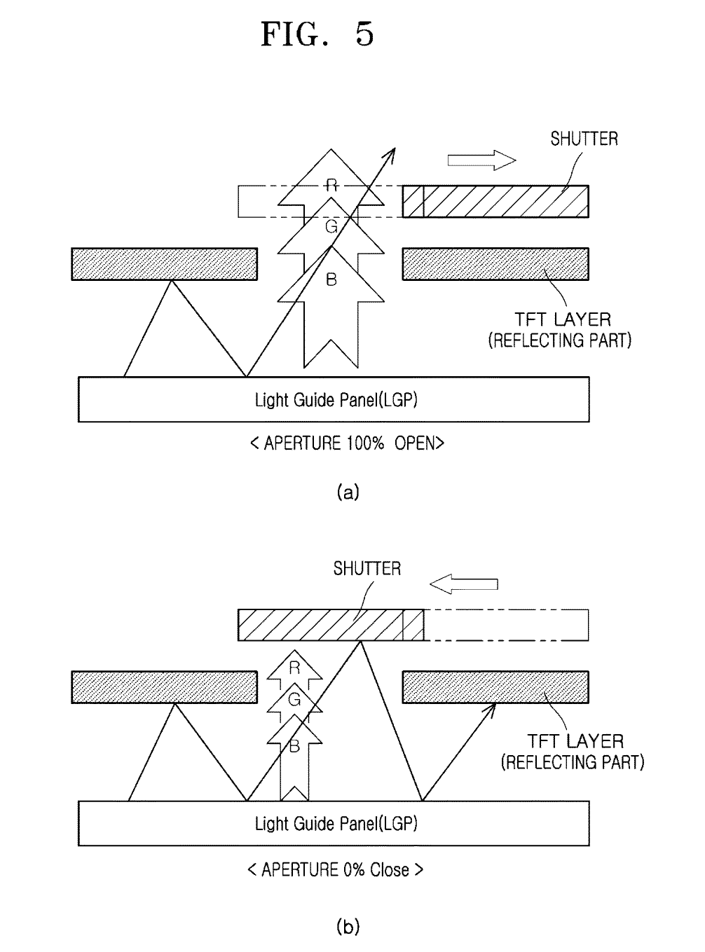

The PGU driving unit 120 may control turn-on/off of pixels forming the PGU 130 based on a display area and position (or coordinate) information of an HUD picture to be projected on the windshield through the PGU 130, in embodiments, a picture including HUD information, according to control of the control unit 110, or controls opening/closing the shutters of the respective pixels (refer to FIG. 5).

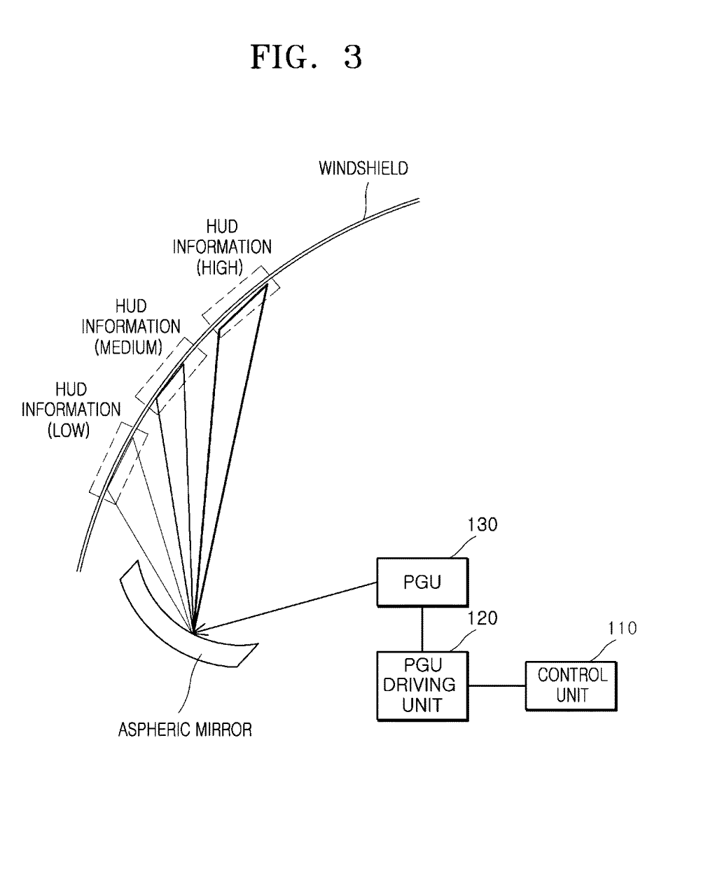

At this time, as illustrated in FIG. 2, the HUD in accordance with the first embodiment of the present invention may reflect the HUD picture projected from the PGU 130 onto the aspheric mirror through a falling mirror, and the HUD picture reflected through the aspheric mirror may be displayed on the windshield. Alternatively, as illustrated in FIG. 3, the PGU 130 may directly project an HUD picture on the aspheric mirror such that the HUD picture reflected through the aspheric mirror can be displayed on the windshield.

In FIG. 3, however, when the HUD picture projected from the PGU 130 is reflected only once through the aspheric mirror and projected on the windshield, the left and right of the HUD picture are inverted. Thus, the left and right of the picture to be projected from the PGU 130 need to be previously inverted. Therefore, the control unit 110 may control the PGU 130 to output a picture of which the left and right are inverted.

The display level of the HUD information (or HUD picture) corresponding to the eye level of the driver and the PGU area and coordinate information corresponding to the display level of the HUD information (or HUD picture) may be previously stored in the form of a lookup table in an internal memory.

Furthermore, the eye level information of the driver may be directly inputted by the driver, or automatically detected by an eye level detector including one or more sensors (for example, an infrared sensor and a camera sensor) and then inputted. Alternatively, the driver may not input the eye level information, but adjust his/her eye level while seeing the display level of the HUD information (or HUD picture) in person.

Thus, the HUD in accordance with the first embodiment of the present invention may further include an information input unit (for example, a switch or button) or an adjusting unit (for example, a switch or button for adjusting the display level of the HUD information). Alternatively, through one or more information input units included in AVN (Audio, Video, Navigation) devices within the vehicle or an information output unit having an input function (for example, touch screen), eye level information for each driver or information for adjusting the display level of the HUD information can be inputted.

The PGU 130 may include a MEMS (Transparent Micro Electro Mechanical System) display device or LCD. The maximum brightness of the transparent MEMS may be improved more than those of other display devices (for example, LCD), and provide high resolution. Thus, the transparent MEMS can embody an eye box having a size corresponding to the size of the entire windshield (full eye box). As the eye box is embodied to have a size corresponding to the size of the entire windshield, the control unit 110 may adjust the HUD information to a desired size and display the HUD picture at a desired position of the windshield, based on software. Furthermore, the transparent MEMS may embody the RGB colors in one pixel according to a time sequence method, using a mechanical shutter method. Thus, the transparent MEMS can be reduced in size.

In the present embodiment, it has been described that the PGU driving unit 120 controls turn-on/off of the respective pixels forming the PGU 130 or controls opening/closing of the shutters of the respective pixels. In reality, however, the control unit 110 may perform the function of the PGU driving unit 120.

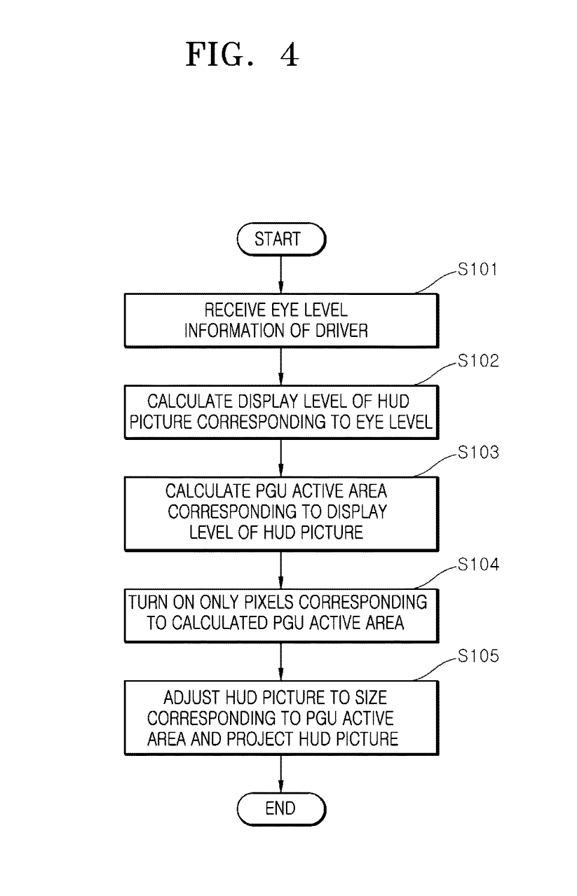

FIG. 4 is a flowchart for describing a control method of an HUD in accordance with the first embodiment of the present invention.

As illustrated in FIG. 4, the control unit 110 may receive the eye level information of a driver at step S101.

The eye level information may be directly inputted from the driver, or automatically detected and inputted by the eye level detector. Alternatively, eye level information stored in the internal memory for each driver may be extracted and inputted.

The control unit 110 may calculate the display level of HUD information (or HUD picture) corresponding to the eye level information of the driver, at step S102. The display level may indicate the display level of the HUD information to be displayed on the windshield.

For example, the control unit 110 may calculate the display level of the HUD information corresponding to the eye level information of the driver, using a lookup table or preset equation. The display level may indicate the display level of the HUD information to be displayed on the windshield.

When the display level of the HUD information, in embodiments, the display level of the HUD information to be displayed on the windshield is calculated, the control unit 110 may calculate a PGU active area corresponding to the calculated display level of the HUD information and the position of the PGU active area, at step S130 (refer to FIG. 5).

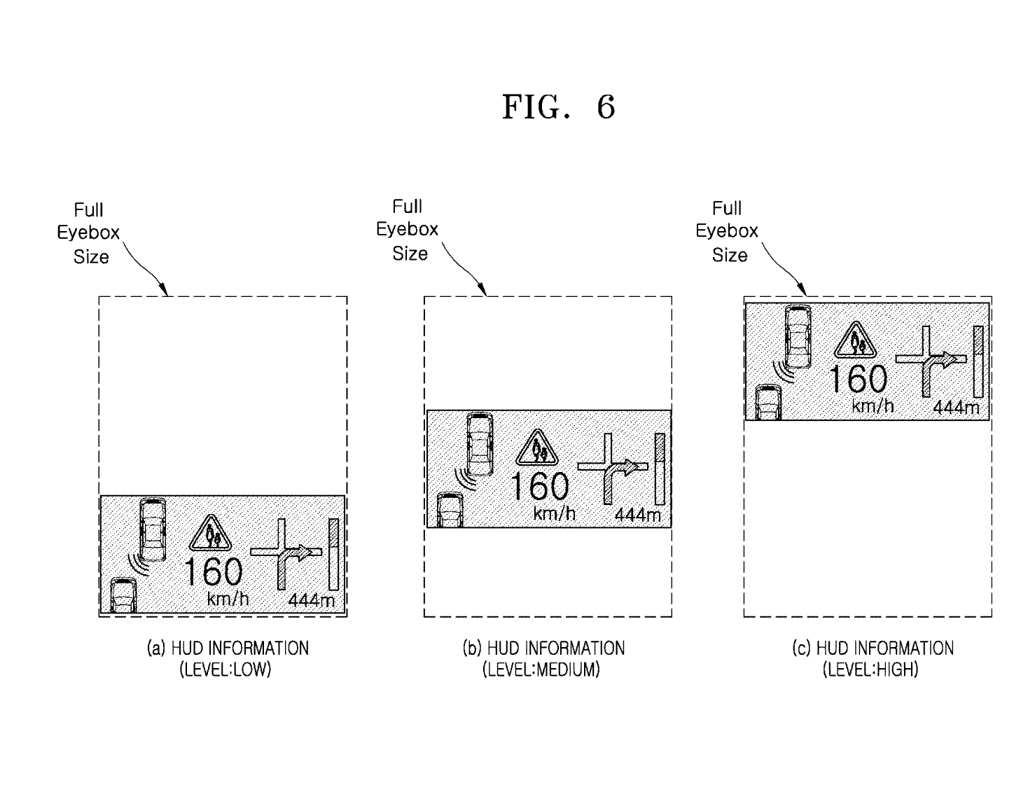

For example, when the display level of the HUD information (or HUD picture) is low, the control unit 110 may calculate the PGU active area and the position of the PGU active area such that the HUD information can be displayed at the lower part of the full eye box, as illustrated in FIG. 6A. For example, when the display level of the HUD information (or HUD picture) is high, the control unit 110 may calculate the PGU active area and the position of the PGU active area such that the HUD information can be displayed at the upper part of the full eye box, as illustrated in FIG. 6C. Furthermore, when the display level of the HUD information (or HUD picture) is intermediate (or equal to the reference level), the control unit 110 may calculate the PGU active area and the position of the PGU active area such that the HUD information can be displayed at the intermediate part of the full eye box, as illustrated in FIG. 6B.

When the PGU active area and the position of the PGU active area, which correspond to the display level of the HUD information (or HUD picture), are calculated, the control unit 110 may turn on only pixels corresponding to the PGU active area and the position of the PGU active area, at step S104.

In embodiments, the control unit 110 may open only the shutters of pixels corresponding to the PGU active area and the position thereof. When the shutters of the pixels corresponding to the PGU active area are opened as described above, the HUD information may be projected only from the corresponding area in which the shutters are opened. In embodiments, the control unit 110 may divide the entire screen area of the PGU 130 (for example, the entire screen area on which HUD information can be projected), and output the HUD information (or HUD picture) only through a divided area corresponding to the PGU active area. In the entire screen area of the PGU 130, all pixels corresponding to an inactive area may be turned off to reduce power consumption.

At this time, the control unit 110 may adjust brightness by controlling the shutter aperture of the PGU 130. An aperture of 100% may indicate open, and an aperture of 0% may indicate close.

For reference, in order to minimize a brightness loss in each pixel of the PGU 130, the shutter and the TFT layer (reflecting part) may be coated with a reflecting mirror. Then, a reflectance of 90% or more can be acquired.

Furthermore, the control unit 110 may adjust the HUD information (or HUD picture) to a size corresponding to the active area of the PGU 130, and project the HUD information (or HUD picture), at step S105.

Thus, the HUD information (or HUD picture) may be displayed at a position of the windshield, corresponding to the eye level of the driver.

In accordance with the first embodiment of the present invention, the HUD and the control method thereof can display HUD information on the windshield of the vehicle by adjusting the level of the eye box through a software according to the eye level of the driver, without using a physical aspheric lens driving motor. Furthermore, although the display level of the HUD information displayed on the windshield is adjusted, the HUD and the control method can prevent distortion. Furthermore, the number of mirrors for reflecting HUD information can be reduced, and the edge-type backlight may be used. Thus, the volume and weight of the HUD module can be reduced.

### Second Embodiment

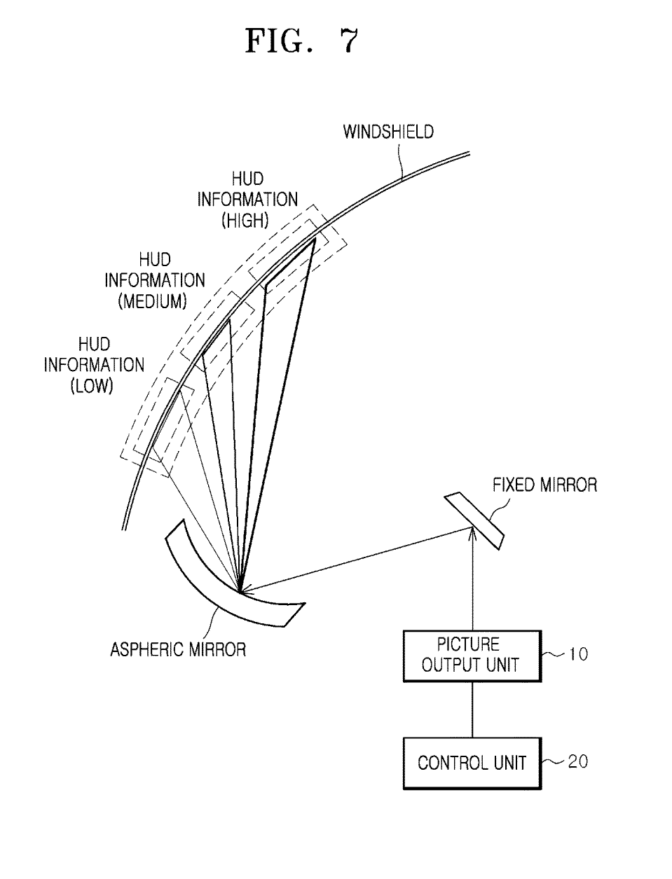

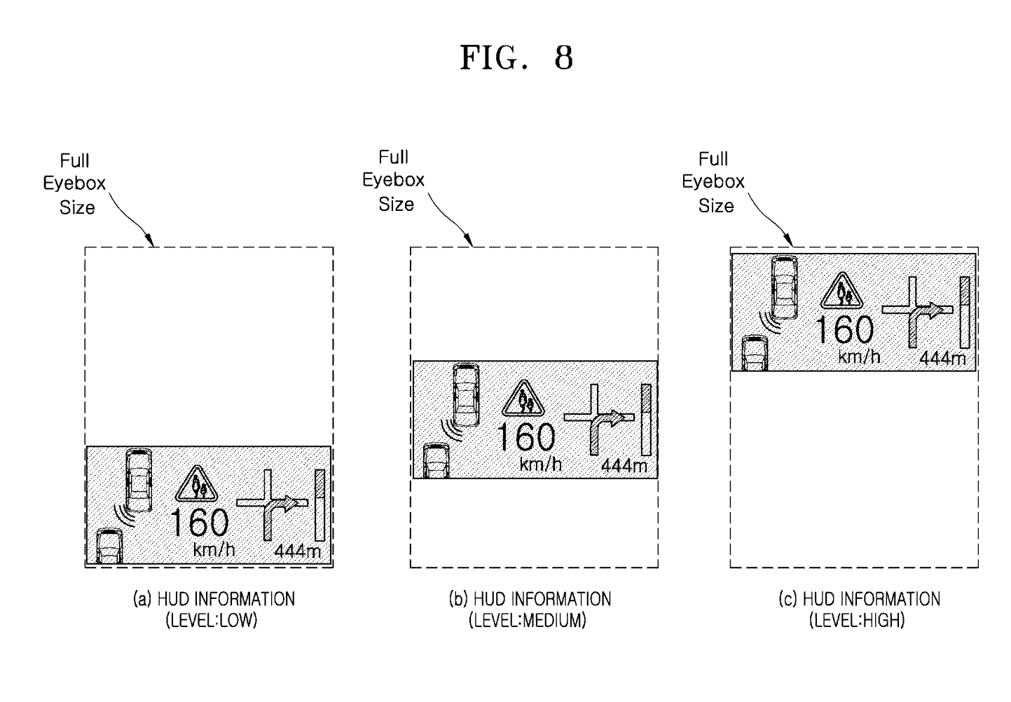

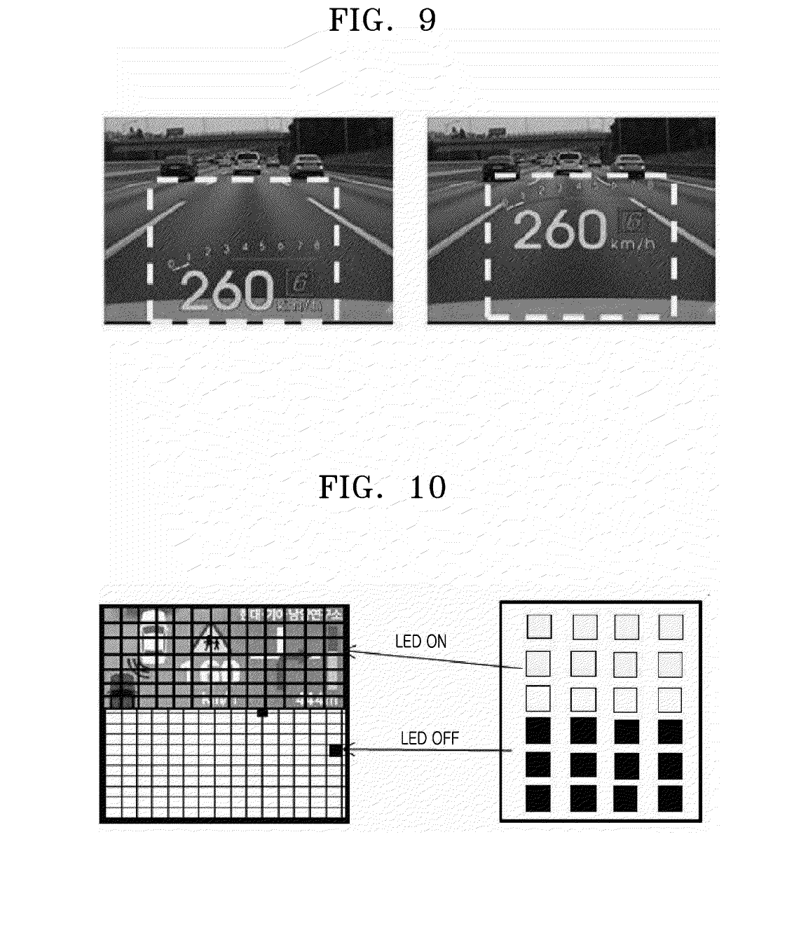

FIG. 7 is a diagram illustrating a schematic configuration of an HUD for a vehicle in accordance with a second embodiment of the present invention. FIG. 8 is a diagram for describing a method for adjusting a projection position of contents which are displayed on a windshield by the HUD for a vehicle in accordance with the second embodiment of the present invention. FIG. 9 is a diagram for describing the shape of a picture projected by the HUD in accordance with the second embodiment of the present invention. FIG. 10 is a diagram for describing a dimming control method of a picture output unit in the HUD in accordance with the second embodiment of the present invention. Referring to FIGS. 7 to 10, the HUD for a vehicle in accordance with the second embodiment of the present invention will be described as follows.

As illustrated in FIG. 7, the HUD for a vehicle in accordance with the second embodiment of the present invention may include a picture output unit 10 and a control unit 20.

The picture output unit 10 may output a picture to be projected onto a windshield according to control of the control unit 20. In embodiments, the control unit 20 may control the picture output unit 10 to output a picture such that the picture is projected in a visible area of a driver. Furthermore, the picture outputted from the picture output unit 10 may be reflected through an aspheric mirror, and projected onto the windshield.

The HUD may further include one or more mirrors for reflecting a picture outputted from the picture output unit 10 onto the aspheric mirror.

As illustrated in FIG. 10, the picture output unit 10 may turn on/off pixels forming the picture output unit 10, based on the display area and position information of a picture to be outputted onto the windshield, according to the control of the control unit 20. At this time, the picture output unit 10 may include an LCD (Liquid Crystal Display) device, and each of the pixels may include an LED (Light Emitting Diode). In this case, the LEDs may be arranged in a plurality of lines, and include edge-type LEDs which send light to the center, reflect the light through a light guide panel, and emit the reflected light to the front. Furthermore, each RGB (Red-Green-Blue) segment of the LCD device may form one pixel.

The control unit 20 may determine the position of contents to be projected onto the windshield. The projection position may be directly inputted from a driver through an information input unit or information adjusting unit, or automatically inputted based on an eye level detected through an external eye level detector, or a projection position for each driver may be previously stored in a storage unit and retrieved through the control unit 20.

Thus, according to an eye level suitable for the most comfortable field of vision for a driver, the control unit 20 may generate a picture to be projected onto the windshield, and calculate the display area and position of the picture to be projected onto the windshield.

For example, as illustrated in FIG. 8, the display level of information displayed on the windshield may be lowered when the eye level of the driver is high (level: low), and raised when the eye level of the driver is low (level: high).

The control unit 20 may receive information from electronic devices (for example, navigation system, dashboard, and multimedia device) in the vehicle, in order to generate a picture to be projected onto the windshield. The information may indicate information to be projected onto the windshield through the HUD, and the picture to be projected onto the windshield for each kind of vehicle may include a composite picture containing one or more pieces of information.

The control unit 20 may determine an active area for outputting a picture in an available output area for the picture output unit 10, based on the determined projection position. Then, the control unit 20 may control the picture output unit 10 based on the determined active area. At this time, the available output area for the picture output unit 10 may indicate the full eye box formed in the visible area of a driver, and the control unit 20 may determine an active area within the full eyebox image.

When the active area for outputting a picture is determined, the control unit 20 may control the picture output unit 10 to output a picture only in the active area. For example, as illustrated in FIG. 10, the control unit 20 may turn on pixels corresponding to the active area, and turn off pixels which are not included in the active area. The active area may indicate an output area of the picture output unit 10, which corresponds to an actual display area of the picture to be projected onto the windshield.

The control unit 20 may determine the active area, based on a lookup table stored in the storage unit.

At this time, as illustrated in FIG. 7, the HUD in accordance with the second embodiment of the present invention may reflect a picture projected from the picture output unit 10 onto the aspheric mirror through a fixed mirror, such that the picture reflected through the aspheric mirror can be displayed on the windshield. Alternatively, the picture output unit 10 may directly project a picture onto the aspheric mirror such that the picture reflected through the aspheric mirror can be displayed on the windshield.

The projection position of contents, which corresponds to the eye level of a driver, and the active area and coordinate information, of the picture output unit 10, which correspond to the projection position, may be previously stored in the form of a lookup table in the storage unit.

The projection position information may be directly inputted by a driver or automatically inputted based on an eye level detected through the eye level detector which includes one or more sensors (for example, infrared sensor and camera sensor), or a driver may not input the projection position information but manually adjust the projection position information while checking the display level in person.

Thus, the HUD in accordance with the second embodiment of the present invention may further include an information input unit (for example, switch or button) or an information adjusting unit for adjusting the display level (for example, switch or button). Alternatively, through one or more information input units included in an AVN (Audio, Video, Navigation) device within the vehicle or an information output unit having an input function (for example, touch screen), projection position information or display level adjusting information for each driver may be inputted.

As described above, the HUD for a vehicle in accordance with the second embodiment of the present invention may not use a physical aspheric lens driving motor when projecting contents on the windshield. Thus, screen distortion may not occur in a picture displayed on the windshield.

Furthermore, the HUD may control the active area of the display device to display the eyebox while adjusting the level of the eye box in software manner, thereby improving the contrast ratio of an output picture.

Furthermore, the HUD can provide a high-quality image because the contrast ratio is improved and an image loss is not caused by distortion correction.

Furthermore, since the eye level adjusting function may be replaced with the screen split function of the device, the HUD can rapidly adjust the level of the eye box, thereby improving convenience.

Furthermore, the assembling process can be simplified, and the weight and cost of the product can be reduced.

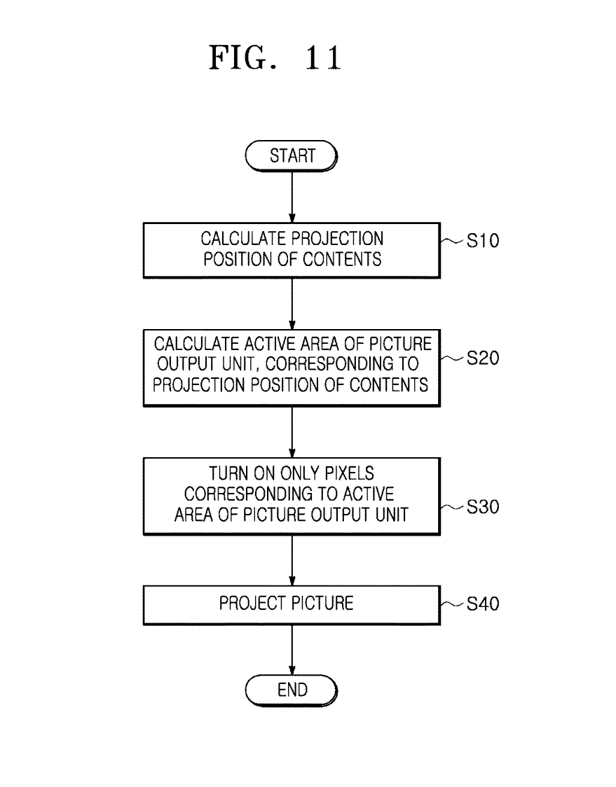

FIG. 11 is a flowchart for describing a control method of an HUD in accordance with the second embodiment of the present invention.

As illustrated in FIG. 11, the control unit 20 may calculate the projection position of contents to be projected onto the windshield, at step S10. The projection position may be directly inputted from a driver through an information input unit or information adjusting unit, or automatically inputted based on an eye level detected through an external eye level detector, or a projection position for each driver, stored in the storage unit, may be retrieved and inputted. At this time, the projection position may be calculated through a lookup table stored in the storage unit or a preset equation.

When the projection position of the contents is calculated at step S10, the control unit 20 may calculate an active area of the picture output unit 10, corresponding to the projection position of the contents, at step S20. The control unit 20 may determine an active area for outputting a picture in the available output area for the picture output unit 10, based on the projection position determined at step S10. Then, the control unit 20 may control the picture output unit 10 based on the determined active area. At this time, the available output area for the picture output unit 10 may indicate the full eye box formed in the visible area of a driver, and the control unit 20 may determine an active area in the full eyebox image. Furthermore, the control unit 20 may determine the active area, based on the lookup table stored in the storage unit.

When the active area of the picture output unit 10 is determined at step S20, the control unit 20 may turn on pixels corresponding to the active area at step S30. In embodiments, the control unit 20 may control the picture output unit 10 to output a picture only in the active area. At this time, the control unit 20 may turn off pixels which are not included in the active area. The active area may indicate an output area of the picture output unit, which corresponds to an actual display area of the picture to be projected onto the windshield.

Through the control of step S30, the control unit 20 may project the picture onto the windshield at step S40.

As described above, the control method of the HUD in accordance with the second embodiment of the present invention may not use a physical aspheric lens driving motor when projecting contents on the windshield. Thus, screen distortion may not occur in a picture displayed on the windshield.

Furthermore, the control method may control the active area of the display device to display the eyebox while adjusting the level of the eye box in software manner, thereby improving the contrast ratio of an output picture.

Furthermore, the control method can provide a high-quality image because the contrast ratio is improved and an image loss is not caused by distortion correction.

Furthermore, since the eye level adjusting function may be replaced with the screen split function of the device, the control method can rapidly adjust the level of the eye box, thereby improving convenience.

Furthermore, the assembling process can be simplified, and the weight and cost of the product can be reduced.

Although embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A head up display (HUD) for a vehicle, comprising:
an aspheric mirror configured to reflect an HUD picture to a windshield;
a picture generation unit (PGU) configured to directly project the HUD picture on the aspheric mirror; and
a control unit configured to calculate a display level of the HUD picture to be displayed on the windshield, based on eye level information of a driver, and control the PGU to output the HUD picture at a position and area corresponding to the calculated display level.

2. The HUD of claim 1, wherein according to the eye level of the driver, the control unit rotates the HUD picture based on an arbitrary axis, such that the HUD picture seems to lie in the horizontal direction.

3. The HUD of claim 1, wherein the display level of the HUD picture to be displayed on the windshield and the area and position information corresponding to the display level are stored in the form of a lookup table in an internal memory.

4. The HUD of claim 1, further comprising:
one or more eye level information input units;
an information adjusting unit configured to adjust the display level of the HUD picture; and
one or more information input units formed in AVN (Audio, Video, and Navigation) devices within the vehicle.

5. The HUD of claim 1, wherein the eye level information is directly inputted from the driver through an information input unit or information adjusting unit, an external eye level detector automatically detects and inputs the eye level information, or the control unit extracts eye level information stored in an internal memory for each driver.

6. The HUD of claim 1, wherein the PGU comprises a transparent MEMS (Micro Electro Mechanical System) display device or LCD.

7. The HUD of claim 1, wherein the control unit controls turn-on/off of pixels of a transparent MEMS display device included in the PGU or controls opening/closing of the shutters of the pixels, based on the display area and position information of the HUD picture to be projected on the windshield through the PUG,
wherein the control unit controls brightness of the HUD picture by adjusting the shutter apertures of pixels of a transparent MEMS display device included in the PGU.

8. A control method of an HUD for a vehicle, comprising:
receiving, by a control unit, eye level information of a driver;
calculating, by the control unit, a display level of an HUD picture to be displayed on a windshield; and
controlling, by the control unit, a PGU to output the HUD picture to a position and area corresponding to the calculated display level on the windshield.

9. The control method of claim 8, wherein in the controlling of the PUG to output the HUD picture,
according to the eye level of the driver, the control unit rotates the HUD picture based on an arbitrary axis, such that the HUD picture seems to lie in the horizontal direction.

10. The control method of claim 8, wherein the display level of the HUD picture to be displayed on the windshield, and the area and position information corresponding to the display level are stored in the form of a lookup table in an internal memory.

11. The control method of claim 8, wherein the PGU comprises a transparent MEMS display device.

12. The control method of claim 8, wherein in the controlling of the PGU to output the HUD picture,
the control unit controls turn-on/off of pixels of a transparent MEMS display device included in the PGU or controls opening/closing of the shutters of the pixels, based on the display area and position information of the HUD picture to be projected on the windshield through the PUG,
Wherein the control unit controls brightness of the HUD picture by adjusting the shutter apertures of pixels of a transparent MEMS display device included in the PGU.

13. An HUD for a vehicle, comprising:
a picture output unit configured to output a picture to be projected onto a windshield;
an aspheric mirror configured to reflect the picture outputted from the picture output unit onto the windshield; and
a control unit configured to determine a projection position of contents to be projected onto the windshield, determine an active area for outputting a picture in an available output area for the picture output unit, based on the determined projection position, and control the picture output unit based on the determined active area.

14. The HUD of claim 13, wherein the control unit directly receives the projection position from a driver through an information input unit or an information adjusting unit, automatically inputs a projection position based on an eye level detected through an external eye level detector, or retrieves projection position information for each driver, stored in a storage unit.

15. The HUD of claim 13, wherein the picture output unit comprises an LCD device, and performs local dimming through input data of pixels on a basis of a plurality of display blocks which individually irradiate light through a plurality of pixel blocks, and
when controlling the picture output unit, the control unit turns on pixels which are included in the active area, and turns off pixels which are not included in the active area.

16. The HUD of claim 13, further comprising:
one or more projection position input units;
an information adjusting unit for adjusting the display level of the picture; and
one or more information input units included in an AVN (Audio, Video, Navigation) device in the vehicle.

17. The HUD of claim 13, further comprising a storage unit configured to store the projection position of contents to be projected onto the windshield and the position information of the active area corresponding to the projection position, in the form of a lookup table.

18. A control method of a display device, comprising:
determining, by a control unit, the projection position of contents to be projected onto a windshield;
determining, by the control unit, an active area for outputting a picture in an available output area, based on the determined projection position; and
outputting, by the control unit, a picture based on the determined active area.

19. The control method of claim 18, wherein in the determining of the projection position of the contents,
the control unit directly receives the projection position from a driver through an information input unit or an information adjusting unit, automatically inputs a projection position based on an eye level detected through an external eye level detector, or retrieves projection position information for each driver, stored in a storage unit.

20. The control method of claim 18, wherein in the outputting of the picture,
the control unit performs local dimming to improve the contrast ratio of an output picture, and
when controlling the picture output unit, the control unit turns on pixels which are included in the active area, and turns off pixels which are not included in the active area.
